(19) United States
(12) Patent Application Publication
(10) Pub. No.: US 2012/0005566 A1
(43) Pub. Date: Jan. 5, 2012

(54) ADDING A COMPREHENSION MARKER TO A SOCIAL NETWORK TEXT ENTRY

(75) Inventors: BERNADETTE A. CARTER, RALEIGH, NC (US); AL CHAKRA, APEX, NC (US); ORIANA J. LOVE, AUSTIN, TX (US)

(73) Assignee: INTERNATIONAL BUSINESS MACHINES CORPORATION, ARMONK, NY (US)

(21) Appl. No.: 12/827,220

(22) Filed: Jun. 30, 2010

(51) Int. Cl. G06F 17/21

(52) U.S. Cl. 715/230; 715/256

(57) ABSTRACT

A computer implemented method provides dynamically altered versions of a comprehension marker for a social network text entry. A computer presents a comprehension marker for a text entry in a social network. The comprehension marker provides additional information to explain the text entry. Dynamically altered versions of the comprehension marker from other readers are then received and presented.

### BACKGROUND

The present disclosure relates to the field of computers, and specifically to electronic messages posted by computers. Still more particularly, the present disclosure relates to presenting comprehension markers with electronic markers.

Electronic messages posted by users on computers is a popular way for members of a social network to keep in touch. These messages may be web log (blog) entries, microblog entries (e.g., messages entered from a cell phone via text messaging), etc. The messages let other members of the social network know what the message posting party is currently doing, what her opinions are on current events, what his plans are in response to certain events, etc.

### BRIEF SUMMARY

In one embodiment of the present disclosure, a computer implemented method provides dynamically altered versions of a comprehension marker for a social network text entry. A computer presents a comprehension marker for a text entry in a social network. The comprehension marker provides additional information to explain the text entry. Dynamically altered versions of the comprehension marker from other readers are then received and presented.

In one embodiment of the present disclosure, a computer system comprises a central processing unit and a memory coupled to the central processing unit, wherein the memory comprises software that, when executed, causes the central processing unit to implement: detecting a text entry on a social network; and presenting a comprehension marker for the text entry, wherein the comprehension marker provides additional information to explain the text entry, and wherein the comprehension marker has been co-authored by an author of the text entry and a reader of the text entry.

In one embodiment of the present disclosure, a computer program product comprises a computer readable storage medium having computer readable program code embodied therewith. The computer readable program code comprises: computer readable program code to detect a text entry on a social network; and computer readable program code to present a comprehension marker for the text entry, wherein the comprehension marker provides additional information to explain the text entry, and wherein the comprehension marker has been co-authored by an author of the text entry and a reader of the text entry.

### BRIEF DESCRIPTION OF THE SEVERAL VIEWS OF THE DRAWINGS

FIG. 1 depicts an exemplary computer in which the present disclosure may be implemented;

FIG. 2 illustrates an exemplary user interface displaying a social network text entry and a comprehension marker for the social network text entry;

FIG. 3 depicts an exemplary user interface that displays ranked comprehension markers, and

FIG. 4 is a high level flow chart of one or more exemplary steps taken by a computer to provide a comprehension marker to a social network text entry.

### DETAILED DESCRIPTION

As will be appreciated by one skilled in the art, the present disclosure may be embodied as a system, method or computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product embodied in one or more computer-readable medium(s) having computer-readable program code embodied thereon.

Any combination of one or more computer-readable medium(s) may be utilized. The computer-readable medium may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

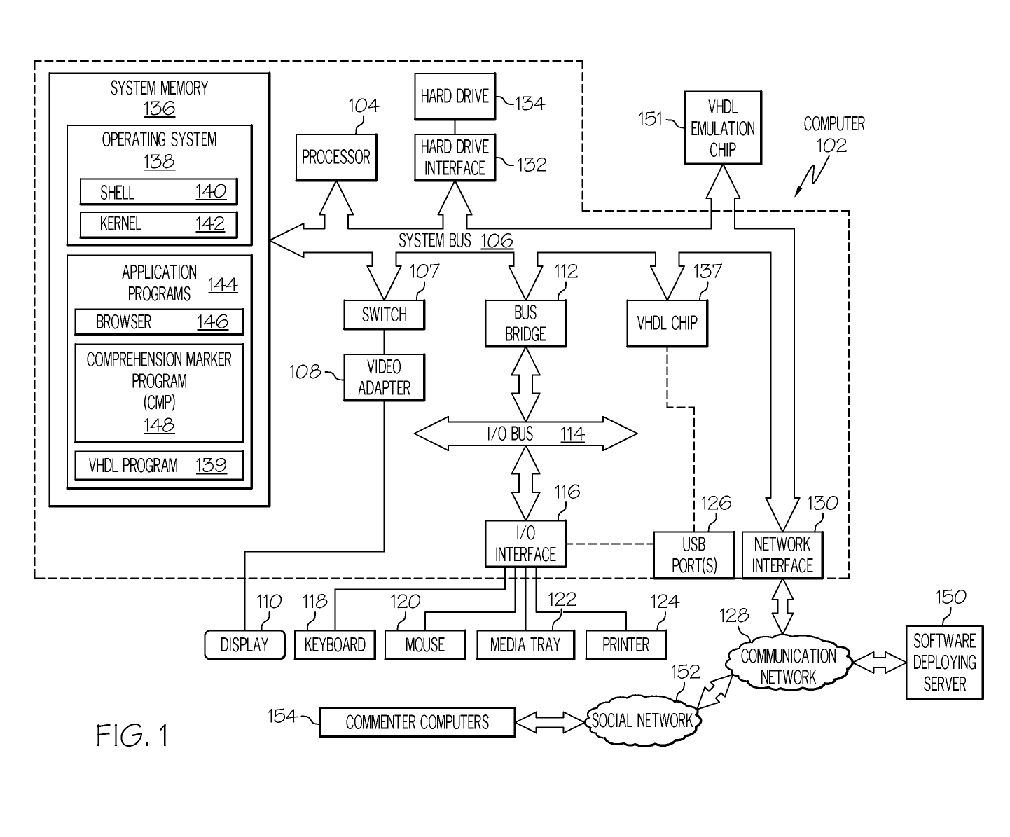

With reference now to the figures, and in particular to FIG. 1, there is depicted a block diagram of an exemplary computer 102, which may be utilized by the present disclosure. Note that some or all of the exemplary architecture, including both depicted hardware and software, shown for and within computer 102 may be utilized by software deploying server 150, and/or commenter computers 154.

Computer 102 includes a processor unit 104 that is coupled to a system bus 106. Processor unit 104 may utilize one or more processors, each of which has one or more processor cores. A video adapter 108, which drives/supports a display 110, is also coupled to system bus 106. In one embodiment, a switch 107 couples the video adapter 108 to the system bus 106. Alternatively, the switch 107 may couple the video adapter 108 to the display 110. In either embodiment, the switch 107 is a switch, which may be mechanical, that allows the display 110 to be coupled to the system bus 106, and thus to be functional only upon execution of instructions (e.g., comprehension marker program—CMP 148 described below) that support the processes described herein.

System bus 106 is coupled via a bus bridge 112 to an input/output (I/O) bus 114. An I/O interface 116 is coupled to I/O bus 114. I/O interface 116 affords communication with various I/O devices, including a keyboard 118, a mouse 120, a media tray 122 (which may include storage devices such as CD-ROM drives, multi-media interfaces, etc.), a printer 124, and (if a VHDL chip 137 is not utilized in a manner described below), external USB port(s) 126. While the format of the ports connected to I/O interface 116 may be any known to those skilled in the art of computer architecture, in one embodiment some or all of these ports are universal serial bus (USB) ports.

As depicted, computer 102 is able to communicate with a software deploying server 150 and/or electronic message server 152 via network 128 using a network interface 130. Network 128 may be an external network such as the Internet, or an internal network such as an Ethernet or a virtual private network (VPN).

A hard drive interface 132 is also coupled to system bus 106. Hard drive interface 132 interfaces with a hard drive 134. In one embodiment, hard drive 134 populates a system memory 136, which is also coupled to system bus 106. System memory is defined as a lowest level of volatile memory in computer 102. This volatile memory includes additional higher levels of volatile memory (not shown), including, but not limited to, cache memory, registers and buffers. Data that populates system memory 136 includes computer 102's operating system (OS) 138 and application programs 144.

OS 138 includes a shell 140, for providing transparent user access to resources such as application programs 144. Generally, shell 140 is a program that provides an interpreter and an interface between the user and the operating system. More specifically, shell 140 executes commands that are entered into a command line user interface or from a file. Thus, shell 140, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. Note that while shell 140 is a text-based, line-oriented user interface, the present disclosure will equally well support other user interface modes, such as graphical, voice, gestural, etc.

As depicted, OS 138 also includes kernel 142, which includes lower levels of functionality for OS 138, including providing essential services required by other parts of OS 138 and application programs 144, including memory management, process and task management, disk management, and mouse and keyboard management.

Application programs 144 include a renderer, shown in exemplary manner as a browser 146. Browser 146 includes program modules and instructions enabling a world wide web (WWW) client (i.e., computer 102) to send and receive network messages to the Internet using hypertext transfer protocol (HTTP) messaging, thus enabling communication with software deploying server 150 and other described computer systems.

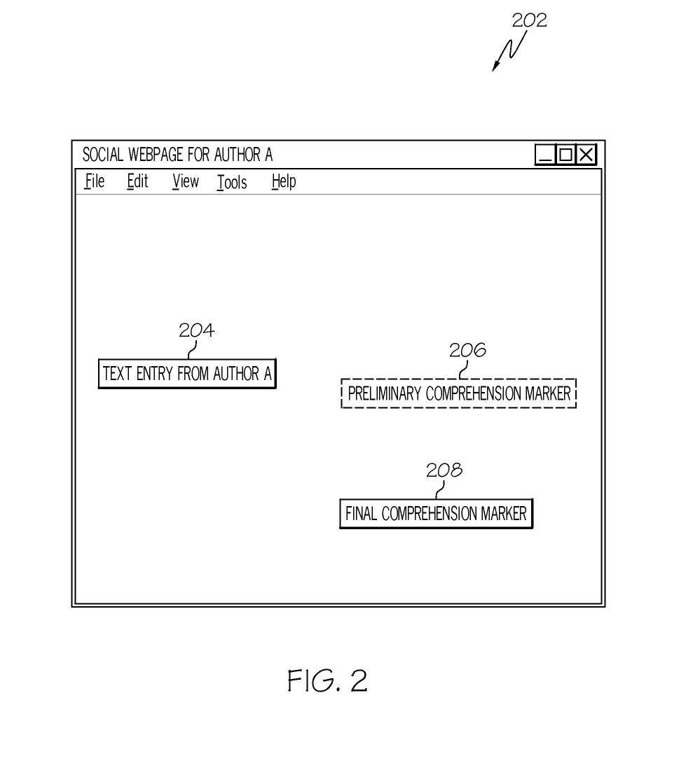

Application programs 144 in computer 102's system memory (as well as software deploying server 150's system memory) also include a comprehension marker program (CMP) 148. CMP 148 includes code for implementing the processes described below, including those described in FIGS. 2-4. In one embodiment, computer 102 is able to download CMP 148 from software deploying server 150, including in an on-demand basis, such that the code from CMP 148 is not downloaded until runtime or otherwise immediately needed by computer 102. Note further that, in one embodiment of the present disclosure, software deploying server 150 performs all of the functions associated with the present disclosure (including execution of CMP 148), thus freeing computer 102 from having to use its own internal computing resources to execute CMP 148.

Also stored in system memory 136 is a VHDL (VHSIC hardware description language) program 139. VHDL is an exemplary design-entry language for field programmable gate arrays (FPGAs), application specific integrated circuits (ASICs), and other similar electronic devices. In one embodiment, execution of instructions from CMP 148 causes VHDL program 139 to configure VHDL chip 137, which may be an FPGA, ASIC, etc.

In another embodiment of the present disclosure, execution of instructions from CMP 148 results in a utilization of VHDL program 139 to program a VHDL emulation chip 151. VHDL emulation chip 151 may incorporate a similar architecture as described above for VHDL chip 137. Once CMP 148 and VHDL program 139 program VHDL emulation chip 151, VHDL emulation chip 151 performs, as hardware, some or all functions described by one or more executions of some or all of the instructions found in CMP 148. That is, the VHDL emulation chip 151 is a hardware emulation of some or all of the software instructions found in CMP 148. In one embodiment, VHDL emulation chip 151 is a programmable read only memory (PROM) that, once burned in accordance with instructions from CMP 148 and VHDL program 139, is permanently transformed into a new circuitry that performs the functions needed to perform the process described below in FIGS. 2-4.

The hardware elements depicted in computer 102 are not intended to be exhaustive, but rather are representative to highlight essential components required by the present disclosure. For instance, computer 102 may include alternate memory storage devices such as magnetic cassettes, digital versatile disks (DVDs), Bernoulli cartridges, and the like. These and other variations are intended to be within the spirit and scope of the present disclosure.

With reference now to FIG. 2, an exemplary user interface 202 displaying a text entry 204 on a social network, and a comprehension marker for the social network text entry is presented. The text entry 204 is an entry from a member of the social network. Examples of such a member include, but are not limited to, bloggers (persons who post entries onto an ongoing web log describing their activities, interests, information, etc.), micro-bloggers (bloggers whose postings are limited to a certain number of characters by the format of the social network), etc. Note that while the commenters are members of a social network in one embodiment, in another embodiment these commenters may be any person having access to the text entry 204, whether in the same social network or not.

A comprehension marker, received from users of commenter computers 154 shown in FIG. 1, provides additional information to explain text entry 204. These users may be part of a same social network, such as social network 152 shown in FIG. 1, and thus only authorized parties who have been deemed qualified to comment on the text entry 204 participate in the commentary marker creation and revisions described herein. In one embodiment, the commenters (users of commenter computers 154) may comment directly on the text entry 204. In another exemplary embodiment, the commenters are users of commenter computers 154 who are commenting on previously posted comments.

In one embodiment, the comprehension marker defines, expands and/or describes an etymology of a word or phrase used in the text entry 204. In one embodiment, the comprehension marker describes current events, societal attitudes, political structures, culture changing activities, etc. that existed when the text entry 204 was initially posted in order to describe the overall content of the text entry 204, including the environment under which text entry 204 was initially posted, thus explaining a potential state of mind (opinion, attitude, bias, etc.) of the author of the text entry 204 at the time the text entry 204 was posted. In one embodiment, the comprehension marker presents biographical information about the author of the text entry in order to better understand the perspective being presented by the author of the text entry 204.

As depicted in FIG. 2, the comprehension marker is initially a preliminary reader-provided comprehension marker, depicted as a preliminary comprehension marker 206. The preliminary comprehension marker 206 is created by a reader of the text entry 204. The author of the text entry 204 revises/edits/approves the preliminary comprehension marker 206 to generate a final comprehension marker 208, such that the final comprehension marker (“comprehension marker”) has been co-authored by both the author of the text entry and the reader of the text entry. In one embodiment, only the final comprehension marker 208 is accessible to other readers. In another embodiment, both the preliminary comprehension marker 206 and the final comprehension marker 208 are accessible to other readers, such that the other readers are able to see how the author and the reader differ in their viewpoints, and under what circumstances the text entry 204 was initiated/posted.

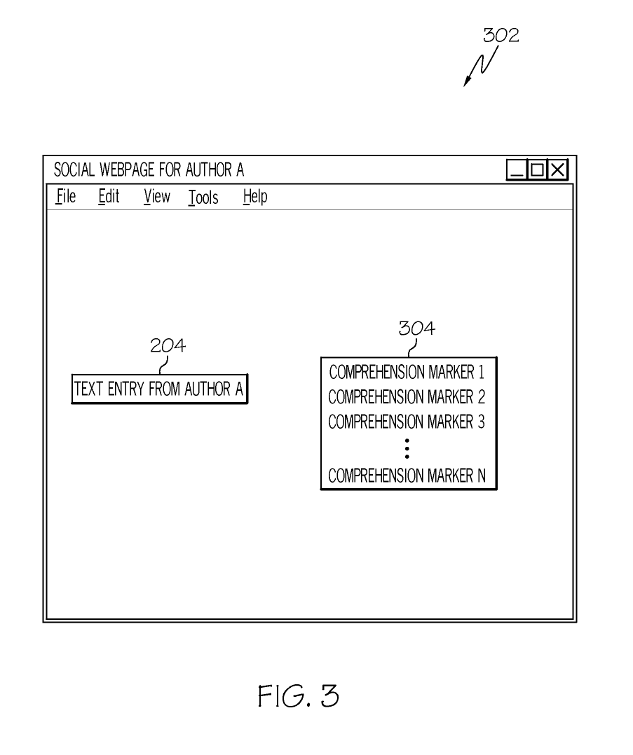

With reference now to FIG. 3, an exemplary user interface 302 that displays ranked comprehension markers is presented. As in FIG. 2, the user interface 302 presents the text entry 204 from the author (“Author A”). However, there are now multiple comprehension markers 1-n(where “n” is an integer) depicted in section 304. In one embodiment, each of these comprehension markers has been co-authored by Author A of the text entry 204. In one embodiment, some or all of the comprehension markers have not been edited, revised, and/or approved by the Author A. In either embodiment, the comprehension markers 1-n can be ranked according to other readers of the text entry. These rankings are dynamic (can change), and thus provide historians and other readers with a representation of how political environments, language, societal attitudes, etc. change over time.

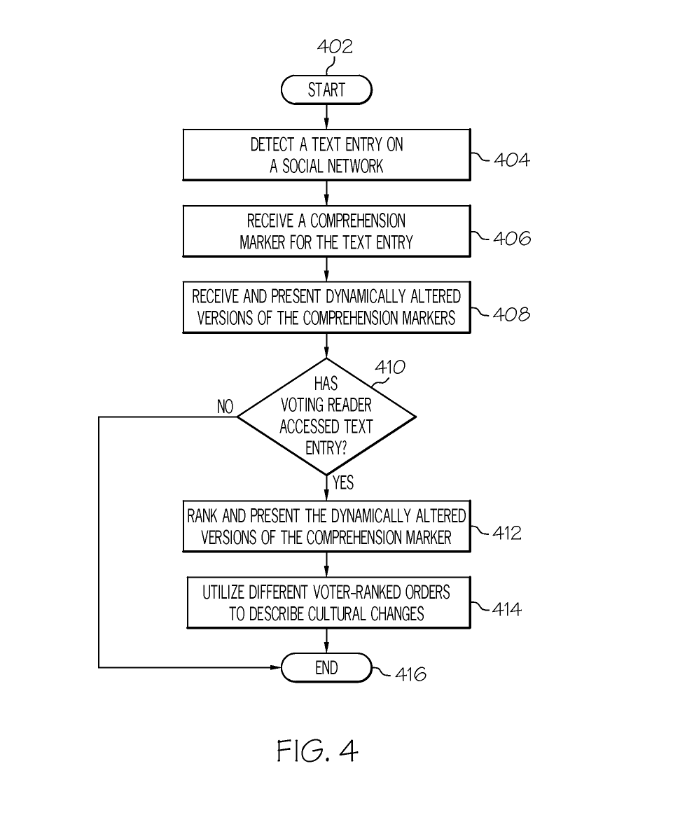

Referring now to FIG. 4, a high-level flow chart of one or more exemplary steps taken by a computer to provide dynamically altered versions of a comprehension marker for a social network text entry is presented. After initiator block 402, a computer detects a text entry on a social network (block 404). As described herein, this text entry may be from a blog, a miniblog or micro blog, etc. As described in block 406, a comprehension marker for the text entry is then received. This comprehension marker provides additional information to explain the text entry, including what the text entry means (e.g., by providing term definitions, acronym abbreviations, etc.), what is “going on” in the world (i.e., societal views, political view and issues, etc.), etc. in order to provide a context for what the text entry is referring to and/or what significance the text entry may hold for present and future cultures. Thus, in various embodiments the comprehension marker provides biographical information about an author of the text entry; the comprehension marker provides a description of current events from when the text entry was initially posted; the comprehension marker provides a description of societal attitudes from when the text entry was initially posted; and/or the comprehension marker provides a description of a political environment from when the text entry was initially posted.

As depicted in block 408, multiple dynamically altered versions of the comprehension marker are received from other readers of the text entry and then presented with the text entry. These multiple dynamically altered versions of the comprehension marker may be solely written by a reader of the text entry and/or previous comprehension markers related to that text entry, or they may be co-authored with the author of the original text entry. If a particular reader (i.e., a potential “voting reader”) has been determined to have accessed the text entry (query block 410), and thus is responding to the text entry rather than simply espousing a preconceived, and possibly unrelated, opinion, then that particular reader and other readers are authorized to vote on one or more of the multiple dynamically altered versions of the comprehensive markers. This voting may be binary (“agree” or “disagree”), or may be scaled (“strongly agree”, “somewhat agree”, “somewhat disagree”, or “strongly disagree”). Based on the votes received, a ranking of the multiple dynamically altered versions of the comprehension marker is made according to votes received from voting readers who have been determined to have accessed the text entry (block 412). The multiple dynamically altered versions of the comprehension marker are then displayed on a display with the text entry in a voter-ranked order (e.g., highest ranked version on top). In one embodiment, a comprehension marker can progress from singular to multidimensional as authors/readers add in new context. A later reader sees a default context based on the highest number of relevancy votes received. This reader may choose to rotate to an other context and vote on the other context as well. If a context in the comprehension marker is seen as irrelevant to most readers, then it will eventually disappear, which can even result in the multidimensional context becoming a singular context. However, if many readers find a context to be valuable, then the context may become the default context if it grows to have the highest relevancy rating. In one embodiment, as more contexts are introduced, the dimensions of the contexts may be represented as a prism as they progress, wherein the multiple contexts can radiate out in different levels and different complexities and wherein the viewer is able to rotate the prism to gain access to multiple available contexts.

As described in block 414, how the multiple dynamically altered versions of the comprehension marker are ranked by voting readers can be used in various ways when the multiple dynamically altered versions of the comprehension marker are ranked in different voter-ranked orders during a defined period of time. That is, the ranked order of a same group of dynamically altered versions of the comprehension marker may change from week to week or year to year. In one embodiment, the different voter-ranked orders are used to describe cultural changes that occurred during the defined period of time.

In one embodiment, these changes in the ranking order of the multiple dynamically altered versions of the comprehension marker are utilized to describe societal attitude changes during the defined period of time. For example, society may agree with a viewpoint of the text entry one year, but society (in general) may change its consensus viewpoint later. Thus, the different rankings of the comprehension markers are useful in describing such changes.

In one embodiment, the ranking order of the multiple dynamically altered versions of the comprehension marker can be utilized to describe political changes during the defined period of time. For example, if a country becomes more conservative during that defined period of time, this political shift may be reflected in how the different comprehension markers are scored in their popularity, perceived accuracy, etc.

In one embodiment, the different voter-ranked orders of the multiple dynamically altered versions of the comprehension marker are used to describe etymological changes during the defined period of time. Thus, if the comprehension markers are directed to providing an explanation of a term or phrase in the text entry, then such a term or phrase may develop a new definition or implication over the course of time. A word that initially was understood to have a first definition may, over time, acquire a new definition or implication. Changes to the ranking of the comprehension markers are thus used to identify such changes to word/term meanings.

In one embodiment, the different voter-ranked orders of the multiple dynamically altered versions of the comprehension marker are used to describe subsequently determined interpretations of the entire text entry during the defined period of time. That is, beside words and terms having changed meanings over the course of time (as described above), an entire text entry can have different interpretations, based on changes in the life of the author of the text entry, changes in societies, politics, economics, etc. These subsequently determined interpretations provide a more accurate understanding/interpretation of the text entry, rather than simply “rewriting history.”

The process ends at terminator block 416.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of various embodiments of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

Note further that any methods described in the present disclosure may be implemented through the use of a VHDL (VHSIC Hardware Description Language) program and a VHDL chip. VHDL is an exemplary design-entry language for Field Programmable Gate Arrays (FPGAs), Application Specific Integrated Circuits (ASICs), and other similar electronic devices. Thus, any software-implemented method described herein may be emulated by a hardware-based VHDL program, which is then applied to a VHDL chip, such as a FPGA.

Having thus described embodiments of the disclosure of the present application in detail and by reference to illustrative embodiments thereof, it will be apparent that modifications and variations are possible without departing from the scope of the disclosure defined in the appended claims.

What is claimed is:

1. A computer implemented method to provide dynamically altered versions of a comprehension marker for a social network text entry, the computer implemented method comprising:
a computer detecting a text entry on a social network;
the computer receiving a comprehension marker for the text entry, wherein the comprehension marker provides additional information to explain the text entry;
the computer receiving multiple dynamically altered versions of the comprehension marker from other readers of the text entry; and
the computer presenting the multiple dynamically altered versions of the comprehension marker with the text entry.

2. The computer implemented method of claim 1, wherein the comprehension marker provides biographical information about an author of the text entry.

3. The computer implemented method of claim 1, wherein the comprehension marker provides a description of current events from when the text entry was initially posted.

4. The computer implemented method of claim 1, wherein the comprehension marker provides a description of societal attitudes from when the text entry was initially posted.

5. The computer implemented method of claim 1, wherein the comprehension marker provides a description of a political environment from when the text entry was initially posted.

6. The computer implemented method of claim 1, further comprising:
determining if a voting reader has accessed the text entry;
ranking the multiple dynamically altered versions of the comprehension marker according to votes received from voting readers who have been determined to have accessed the text entry; and
presenting the multiple dynamically altered versions of the comprehension marker on a display with the text entry in a voter-ranked order.

7. The computer implemented method of claim 6, wherein the multiple dynamically altered versions of the comprehension marker are ranked in different voter-ranked orders during a defined period of time, the computer implemented method further comprising:
utilizing the different voter-ranked orders of the multiple dynamically altered versions of the comprehension marker to describe societal attitude changes during the defined period of time.

8. The computer implemented method of claim 6, wherein the multiple dynamically altered versions of the comprehension marker are ranked in different voter-ranked orders during a defined period of time, the computer implemented method further comprising:
utilizing the different voter-ranked orders of the multiple dynamically altered versions of the comprehension marker to describe political changes during the defined period of time.

9. The computer implemented method of claim 6, wherein the multiple dynamically altered versions of the comprehension marker are ranked in different voter-ranked orders during a defined period of time, the computer implemented method further comprising:
utilizing the different voter-ranked orders of the multiple dynamically altered versions of the comprehension marker to describe etymological changes during the defined period of time.

10. The computer implemented method of claim 6, wherein the multiple dynamically altered versions of the comprehension marker are ranked in different voter-ranked orders during a defined period of time, the computer implemented method further comprising:
utilizing the different voter-ranked orders of the multiple dynamically altered versions of the comprehension marker to describe subsequently determined interpretations of a totality of the text entry during the defined period of time.

11. A computer system comprising:
a central processing unit; and
a memory coupled to the central processing unit, wherein the memory comprises software that, when executed, causes the central processing unit to implement:
detecting a text entry on a social network; and
presenting a comprehension marker for the text entry, wherein the comprehension marker provides additional information to explain the text entry, and wherein the comprehension marker has been co-authored by an author of the text entry and a reader of the text entry.

12. The computer system of claim 11, wherein the software, when executed, further causes the central processing unit to implement:
receiving dynamically altered versions of the comprehension marker from other readers of the text entry; and
the computer presenting the dynamically altered versions of the comprehension marker with the text entry.

13. The computer system of claim 12, wherein the software, when executed, further causes the central processing unit to implement:
determining if a voting reader has accessed the text entry;
ranking the dynamically altered versions of the comprehension marker according to votes received from voting readers who have been determined to have accessed the text entry; and
presenting the dynamically altered versions of the comprehension marker on a display with the text entry in a voter-ranked order.

14. The computer system of claim 13, wherein the dynamically altered versions of the comprehension marker are ranked in different voter-ranked orders during a defined period of time, and wherein the software, when executed, further causes the central processing unit to implement:
utilizing the different voter-ranked orders of the dynamically altered versions of the comprehension marker to describe societal attitude changes during the defined period of time.

15. The computer system of claim 14, wherein the software, when executed, further causes the central processing unit to implement:
utilizing the different voter-ranked orders of the dynamically altered versions of the comprehension marker to describe political changes during the defined period of time.

16. A computer program product comprising:
a computer readable storage medium having computer readable program code embodied therewith, the computer readable program code comprising:
computer readable program code to detect a text entry on a social network; and
computer readable program code to present a comprehension marker for the text entry, wherein the comprehension marker provides additional information to explain the text entry, and wherein the comprehension marker has been co-authored by an author of the text entry and a reader of the text entry.

17. The computer program product of claim 16, the computer readable program code further comprising:
computer readable program code to receive dynamically altered versions of the comprehension marker from other readers of the text entry; and
computer readable program code to present the dynamically altered versions of the comprehension marker with the text entry.

18. The computer program product of claim 17, the computer readable program code further comprising:
computer readable program code to determine if a voting reader has accessed the text entry;
computer readable program code to rank the dynamically altered versions of the comprehension marker according to votes received from voting readers who have been determined to have accessed the text entry; and
computer readable program code to present the dynamically altered versions of the comprehension marker on a display with the text entry in a voter-ranked order.

19. The computer program product of claim 18, wherein the dynamically altered versions of the comprehension marker are ranked in different voter-ranked orders during a defined period of time, the computer readable program code further comprising:
computer readable program code to utilize the different voter-ranked orders of the dynamically altered versions of the comprehension marker to describe societal attitude changes during the defined period of time.

20. The computer program product of claim 18, the computer readable program code further comprising:
utilizing the different voter-ranked orders of the dynamically altered versions of the comprehension marker to describe etymological changes during the defined period of time.
